(19) United States
(12) Patent Application Publication
(10) Pub. No.: US 2003/0026748 A1
(43) Pub. Date: Feb. 6, 2003

(54) Apparatus for producing cosmetic products and relating production process

(76) Inventors: Giuseppe Maio, Zelo Surrigone (IT); Antonio Mandelli, Cernusco Sul Naviglio (IT)

Correspondence Address: AKERMAN, SENTERFITT & EDISON, P.A., SUITE 400, 222 LAKEVIEW AVENUE, WEST PALM BEACH, FL, 33401, US

(21) Appl. No.: 10/207,408

(22) Filed: Jul. 29, 2002

(30) Foreign Application Priority Data
Aug. 2, 2001 (IT) MI2001A001695

(51) Int. Cl. B01F 1/00

(52) U.S. Cl. 422/225

(57) ABSTRACT

The present invention refers to an apparatus for producing cosmetic products comprising a reactor (6) provided with an agitator (8) suitable for mixing lipidic substances and other powder and non-powder ingredients. The apparatus comprises means (1, 2-5, 7, 31-35) for feeding carbon dioxide into the reactor (6) in a liquid phase in non super-critical conditions for use as solvent for said lipidic substances and powders, and means (9-13) for discharging carbon dioxide outside the reactor (6). (FIG. 1).

The present invention refers to an apparatus for producing cosmetic products and relating production process.

Cosmetic products obtained from the mixture of a powder phase with a lipidic, oily or polymeric phase in the presence of a solvent are already known. The mixture may have the aim of treating the powder by improving its characteristics and is carried out in mills of various types where the two phases are mixed for a variable time (sometimes for a long time) to obtain a homogeneous product.

The JP patent 11-47681 describes a method for coating fine particles using a supercritical fluid as the solvent. In an apparatus that uses the above method, the liquid carbon dioxide fed from a tank is conveyed through a valve to a preheating column installed in a controlled-temperature water bath. The carbon dioxide is heated in the latter at a temperature that is greater than the equilibrium temperature of the carbon dioxide, so as to obtain a supercritical fluid that is conveyed to an extraction cell. The latter contains a high molecular weight compound, for example PEG, provided as solute, a solvent, for example ethanol, that enables the high molecular compound to be dissolved in the carbon dioxide in supercritical condition, and fine particles made of at least one non-organic material, such as titanium dioxide. All the above substances are completely dissolved in the carbon dioxide in supercritical condition used as solvent. Then the carbon dioxide in supercritical condition in which the above solute is dissolved is introduced into a controlled-temperature air bath through a heated tube and sprayed by means of nozzles contained therein. In this manner the carbon dioxide in supercritical condition expands and its capacity to dissolve the solute decreases. The final result is constituted of fine particles of titanium dioxide coated with PEG collected by a panel.

In view of the state of the technique described, the object of the present invention is to produce an apparatus for the production of cosmetic products that use carbon dioxide in non-supercritical condition for dissolving fatty substances.

In accordance with the present invention this object is reached by means of an apparatus for producing cosmetic products comprising a reactor fitted with an agitator suitable for mixing lipidic substances and powders in the presence of solvent, characterized in that it comprises means for feeding carbon dioxide in liquid phase in non-supercritical conditions into said reactor for use as solvent for said lipidic substances and powders, and means for discharging carbon dioxide outside said reactor.

In accordance with the present invention it is thus possible to realize a process for producing cosmetic products as defined in claim 13.

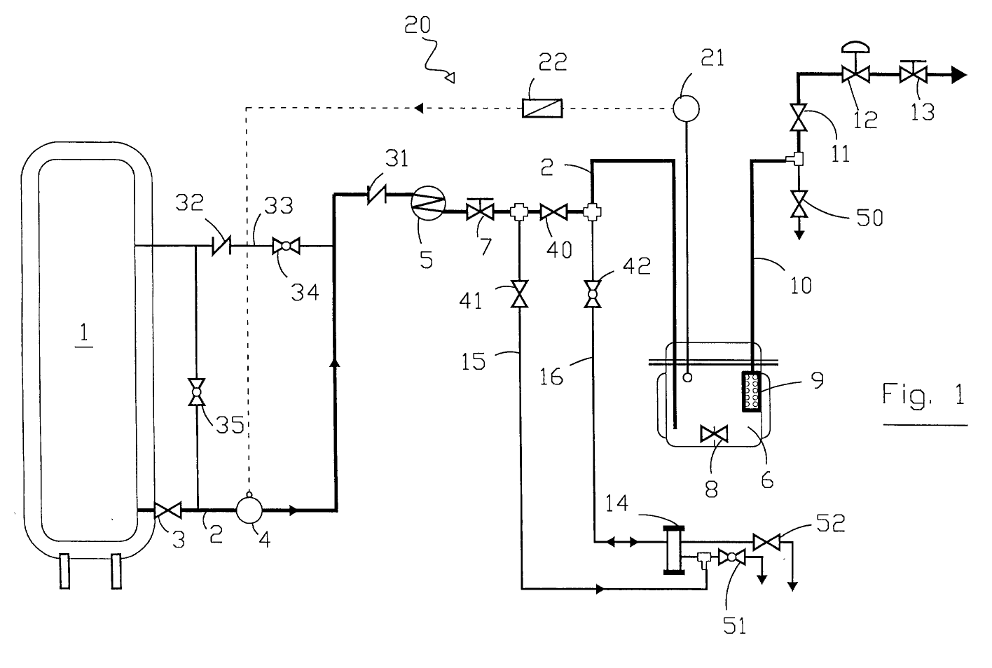

The characteristics and advantages of the present invention will be evident from the following detailed description of an embodiment thereof, illustrated as non-limiting example in the drawing of FIG. 1 in which a schematic view of the apparatus for producing cosmetic products according to the present invention is shown.

The apparatus according to the invention shown in FIG. 1 comprises a tank 1 containing carbon dioxide in the liquid state, for example at a pressure of approximately 20 bar and at a temperature of approximately 20° C. The carbon dioxide in the liquid state and in non super-critical conditions leaves the tank 1 through a duct 2 fitted with a high-pressure valve 3. The liquid carbon dioxide in non super-critical conditions enters a pump 4 capable of increasing its pressure and conveying it to a carbon dioxide/water heat exchanger 5. The liquid obtained is sent to a reactor 6 through a micrometric valve 7 that permits the initial slow passage of the liquid to the reactor 6; in this manner the pressure of the liquid in the reactor 6 reaches 20 bar without provoking rapid expansion of the carbon dioxide which would cause it to freeze. After the pressure in the reactor has reached 20 bar pump 4 is activated.

The reactor 6 contains a mechanical agitator 8 that enables the cosmetic powders and lipidic substances that have been previously added to be mixed with the liquid carbon dioxide in non super-critical conditions which acts as solvent; under working conditions a pressure of for example approximately 60 bar and a temperature of between 20° C. and 25° C. will be reached in the reactor 6.

At the end of mixing the carbon dioxide is filtered by a special filter 9 and is discharged externally through a pipe 10 and special valves 11, 12 and 13, of which the valve 12 can be regulated in pressure and opens only at a pressure which is greater than that preset and the valve 13 is an air valve with manual opening.

The apparatus comprises a small test container 14 connected to the duct 2 upstream from the reactor 6 by means of two ducts 15 and 16 connected to the same duct 2 and each fitted with a valve 41 and a valve 42 respectively; in duct 2 a valve 40 is present between ducts 15 and 16. The container 14 enables the color of a sample of the product present in the reactor 6 to be tested and to make corrections if the product is not that desired. Air valves 51 and 52 are associated with container 14.

The apparatus comprises a device 20 for stopping the pump 4, comprising a level sensor 21 which, when the liquid present in the reactor 6 has reached a preset level, activates a relay 22 that commands pump 4 to stop.

Check valves 31 and 32 are also provided; more specifically, a check valve 31 of the carbon dioxide in the liquid phase into the tank 1 is provided directly in the duct 2 positioned upstream from the exchanger 5 and downstream from the pump 4, and a check valve 32 of the carbon dioxide in gaseous phase into the tank 1, positioned in a pipe 33 connected in derivation to the duct 2 by means of a valve 34. The check valve 32 is connected to the tank 1, and also to the duct 2 between the valve 3 and the pump 4 by means of a valve 35.

The apparatus in FIG. 1 functions as follows.

The liquid carbon dioxide in non super-critical conditions flows out of tank 1 and is conveyed by means of the duct 2 towards the heat exchanger 5. The liquid obtained is sent to the reactor 6 through the micrometric valve 7, which permits the liquid to pass slowly initially so that its pressure in the reactor 6 reaches 20 bar without provoking rapid expansion of the carbon dioxide which would cause it to freeze. When the 20 bar have been reached inside the reactor 6, which means reaching the pressure of equilibrium between reactor 6 and tank 1, pump 4 is activated to send under pressure the liquid with liquid carbon dioxide in non super-critical conditions to the reactor 6. When the preset level of liquid inside the reactor 6 is reached, the device 20 stops the pump in the manner previously described. The liquid carbon dioxide in non super-critical conditions serves as a solvent for lipidic substances and other powder and non-powder ingredients previously poured in the reactor 6; the agitator 8 mixes the substances and the fluid.

When the mixing is completed the carbon dioxide will be discharged externally by means of duct 10 and the valves 11, 12 and 13.

During the preparation of the compound a phase for testing a sample of the product made inside the reactor 6 is provided for. This occurs prior to the closing of the valve 7 and return of the product through duct 2. The valve 40 positioned in duct 2 is opened, as is the valve 41 while the valve 42 remains closed; the product of the reactor 6 flows in duct 15 and reaches the container 14. Once the valve 52 is opened to reduce the pressure in the container 14 the latter can be opened to verify the color of the product and to make suitable corrections if necessary (addition of color or other substances). The sample of the corrected product is conveyed to the reactor 6 by means of duct 16, once the valves 52 and 40 are closed and the valves 7 and 42 opened. The valve 40 is then opened again and the valves 41 and 42 closed to restore the previous working condition.

Once the preparation of the product in the reactor 6 has been completed, the carbon dioxide can be let out through the vent connections consisting of the duct 10 and the open pin valve 50, while the valve 7 remains closed. The reactor 6 can then be opened to discharge the cosmetic product thus obtained, which can be the final product or a coating of some type.

1. Apparatus for producing cosmetic products comprising a reactor (6) provided with an agitator (8) suitable for mixing lipidic substances and powders in the presence of solvent, characterized in that it comprises means (1, 2-5, 7, 31-35) for feeding into said reactor (6) carbon dioxide in a liquid phase in non super-critical conditions for use as solvent for said lipidic substances and powders, and means (9-13) for discharging carbon dioxide outside said reactor (6).

2. Apparatus according to claim 1, characterized in that it comprises a test container (14) connected to said reactor (6) by means of further means (2, 15, 16, 40-42) for feeding said container (14) with a sample of the cosmetic product mixed into the reactor (6) so as to carry out the test and the addition of substances to correct the color or other.

3. Apparatus according to claim 2, characterized in that said further means (2, 15, 16, 40-42) for feeding said test container (14) comprise ducts (2, 15, 16) fitted with valves (7, 40-42) that are alternately opened and closed to determine the conveying of the product sample into the container (14) and the inflow of the corrected sample from the container (14) into the reactor (6).

4. Apparatus according to claim 1, characterized in that said means (1, 2-5, 7, 31-35) for feeding the reactor with carbon dioxide in a liquid phase in non super-critical conditions comprise a tank (1) containing said carbon dioxide in a liquid phase in non super-critical conditions, a valve (7) that permits the initial slow passage of said carbon dioxide in a liquid phase in non super-critical conditions from the tank (1) into the reactor (6) so as to avoid freezing due to an excessive sudden variation in pressure.

5. Apparatus according to claim 4, characterized in that said preset pressure inside the reactor (6) must balance that inside the tank (1).

6. Apparatus according to claim 4, characterized in that said means (1, 2-5, 7, 31-35) for feeding the reactor with carbon dioxide in a liquid phase in non super-critical conditions comprise a pump (4) that is activated once the equilibrium pressure between reactor (6) and tank (1) is reached.

7. Apparatus according to claim 4, characterized in that it comprises a device (20) for stopping the pump (4), said device (20) comprising a level sensor (21) which upon reaching a preset level of the mixture in the reactor (6) commands the pump (4) to stop.

8. Apparatus according to claim 4, characterized in that said means (2, 5, 7, 31-35) for feeding the reactor (6) with carbon dioxide in a liquid phase in non super-critical conditions comprises a carbon dioxide/water heat exchanger (5) upstream of said valve (7).

9. Apparatus according to claim 8, characterized in that said means (2, 5, 7, 31-35) for feeding the reactor (6) with carbon dioxide in a liquid phase in non super-critical conditions comprises check valves (31, 32) of the carbon dioxide in a liquid phase and in a gassy phase positioned upstream of said exchanger (5).

10. Apparatus according to claim 1, characterized in that said means (9, 13) for discharging carbon dioxide outside said reactor (6) comprises a filter (9) inside the reactor (6) associated to a pipe (10) that leads to a pressure valve (12) external to the reactor and to an air valve (13).

11. Apparatus according to claim 10, characterized in that said pressure valve (12) is regulated by a preset pressure.

12. Apparatus according to claim 1, characterized in that it comprises vent connections (9, 10, 50; 2, 42, 16, 14, 52; 2, 40, 41, 15, 51) of the carbon dioxide.

13. Process for producing cosmetic products comprising the preparation of a powder phase, the preparation of a lipidic phase, the mixture of the two phases by means of the use of carbon dioxide in a liquid phase in non super-critical conditions as solvent for obtaining finished cosmetic products, characterized in that during the mixing phase it comprises a phase for taking a sample of the mixed product, a phase for testing said sample and if needed correcting the color of the product mixed by means of adding substances to the sample and a phase of reintegrating the sample into the mixture to obtain the required finished cosmetic product.
